(19) United States
(12) Patent Application Publication
(10) Pub. No.: US 2016/0246480 A1
(43) Pub. Date: Aug. 25, 2016

(54) Method Enabling Creation of Custom Crest with Key Cards

(71) Applicant: Daniel Wallace Copeland, Chapel Hill, NC (US)

(72) Inventor: Daniel Wallace Copeland, Chapel Hill, NC (US)

(21) Appl. No.: 14/627,217

(22) Filed: Feb. 20, 2015

(51) Int. Cl. G06F 3/0484; G06F 3/0482

(52) U.S. Cl. CPC G06F 3/04842; G06F 3/0482; G06F 3/04845

(57) ABSTRACT

This process enables the user to design a custom family or individual crest reflecting those key principles and attributes that are important to them as an individual and/or their family. The user creates or selects quotes and verses or other custom text that represent key principles and/or ideas that are important to them. Then, they select imagery that they believe represent those chosen principles and/or ideas they have identified. They pair that imagery with the specific principles and/or ideas so that each image is specifically symbolic of one principle. Then, the user creates a family crest with the imagery that reflects their key principles and ideas by using those images. The crest is delivered with a set of ‘key cards’ that display each image on the crest with the corresponding quote or verse or principle. This allows the user to create a family crest that reflects those key principles and/or ideas that they have identified as important and have a visual reminder of those things in order to build their individual or family identity.

### BACKGROUND

In a society where a Facebook profile is more likely to drive the identity of a family than truth and real life experiences, American families are losing the battle for their family identity. At Cornerstone Crests, Inc., we have created a process to help address this deterioration of family identity. This process enables families and individuals to create a relevant, modern day, customized crest and uniquely allows them to: 1. Choose custom quotes, verses, lyrics or any other custom verbiage as key principles to be reflected in their crest and, 2. Provides them with a set of ‘key cards’ that include the quotes and key principles they choose along with the associated imagery on their crest. These parts of the process enable the crest to be more than an artifact of their family history, instead it is a relevant visual reminder of who they are today and what they stand for. This is of unique and of extreme value to families, couples, and individuals who seek to establish a stronger family identity and create a visual representation and reminder of who they are as a family. The visual symbolism in the crest is strongly supported by the unique ‘key cards’ delivered with the crest that show the relationship of their custom images to the principle verse or quote they created or selected.

### BRIEF SUMMARY OF THE INVENTION

This process enables a user to build a custom crest that reflects those key principles that are most relevant and important to them personally and/or their family. Key principles can be more than just a single word. These can be any quote, verse, attribute or other text that is important to the family. This process specifically creates a custom family crest with images that symbolize individual family values and the crest is delivered with a set of cards that include the imagery selected and the specific quote or verse that the image represents and symbolizes to the family. The result is a crest with imagery that clearly and directly reflects those attributes that are most important to the family with ‘key cards’ that serve as a meaningful reminder of the symbolism represented by the visuals in their crest.

The process starts with the identification and selection of those key principles that are considered of high importance to the individual or family. This can be quotes, biblical verses, lyrics, attributes or any information selected by the person or persons creating the crest. After identifying these key principles, which can be selected from a database or custom created, the user is able to select imagery that they personally associate with those key principles. Imagery is selected to represent each of the principles that they have identified. After selecting the imagery, the user pairs each principle with the imagery they have selected so that each principle is associated with a specific visual image. This imagery is then used to populate a crest that reflects those key principles of the family or individual and is a visual representation of who they are and what is most important to them. This process can be done by an individual to reflect the key principles of their identity. It can also be done by a family or leader of a family to reflect the key principles of the family as a group. The final crest is delivered with a set of ‘key cards’. A crest with four quadrants will have four ‘key cards’. These cards are unique in that they are not offered by other crest building sites today. The cards include the visual imagery on the crest and the families selected attribute. These key cards are an important reference document to tie the imagery back to those principles that are selected and considered important to the family. These cards tie the imagery to those specific selected principles in a way that reminds those creating the crest of the significance associated with the images.

### BRIEF DESCRIPTION OF THE DRAWINGS

FIG. 1 shows the steps for creating a crest for a family or individual per these steps in any order.

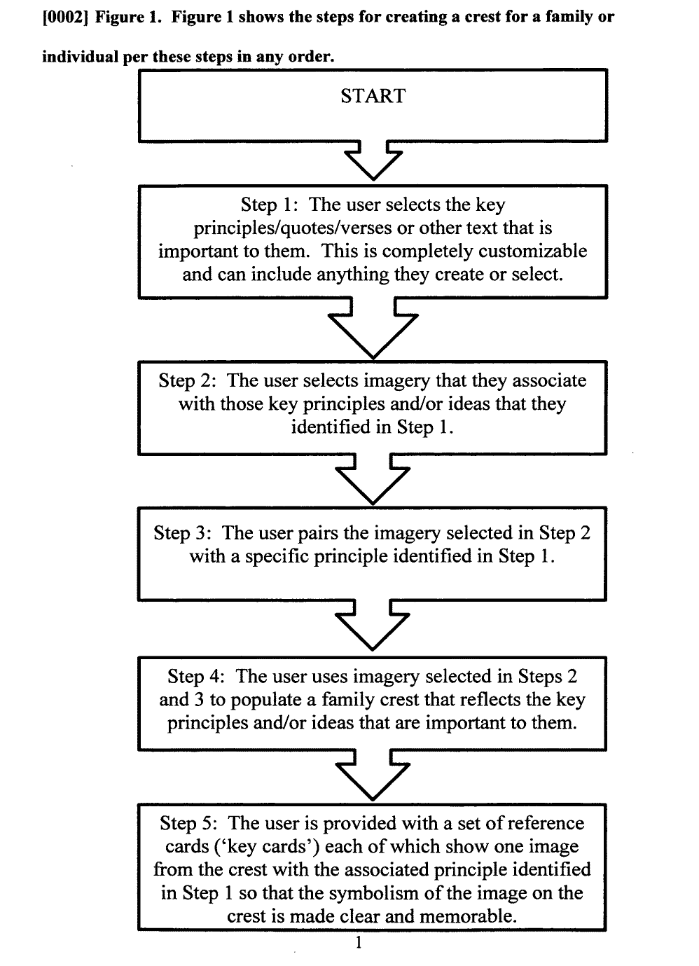

FIG. 2. Shows an example of a custom crest made via this process

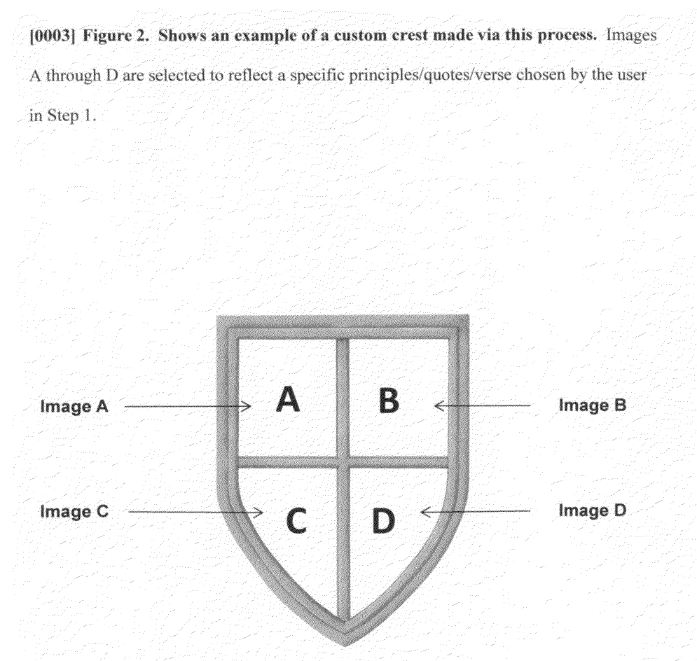

FIG. 3. Shows a set of ‘Key Cards’ for the example crest above. The cards link the imagery to the key quotes and/or verses that were selected as key principles. And serve to remind the user of the significance of the crest.

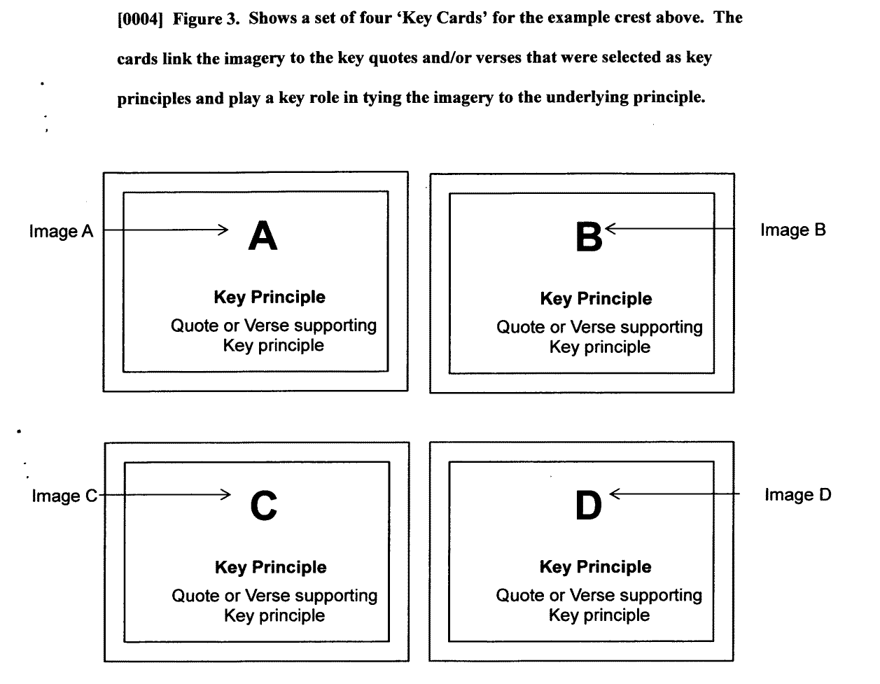

### DETAILED DESCRIPTION AND BEST MODE OF IMPLEMENTATION

This process can be implemented in person in a face to face discussion or via a computer based interface. A user of this process can be guided through the process in person as an individual or as a group at the direction of someone who has been trained in the process. In addition, a potential user of this method can visit a website that guides them through this process. These steps can be performed in any order but a logical flow is described below.

The first step is to identify those key principles and attributes that are most important to the user. This can be any quote, bible verse, text or and principle or idea that they, the user, believe to be particularly meaningful. This is more than a selection of a word or idea from a group of one word attributes. Instead, it includes quotes, verses and any custom text the user would like to use because they believe the language reflects a specific principle important to them or their family. This can be selected via a database of information or it can be custom quote or verse created by a user to reflect those specific principles and attributes that are most important to them. This can include items such as quotes, verses, lyrics and text from known authors or it can include quotes or principles that are personal and specific to the individual or family completing the process. The goal of this step is to identify those things that are of specific importance to the user and perceived by the user to be an important component of their identity.

The user then selects imagery that they believe represents the specific selected principles and/or ideas that they have chosen. These images can be selected from any source including all available art or a select group of images provided to the user via a database or subset of images deemed to be appropriate for this process.

The user then pairs the specific imagery to specific principles such that a certain image represents the underlying principle. This is done at the discretion of the user. This can be done in person with guidance from an individual to get walk through the process or it can be offered via the internet and computer based technology. If done via an Internet interface this can be done via a drag and drop pairing process wherein the user selects images and drags them to the selected text to pair the image and principle.

Or, if conducted in a live setting this could be done with printed images that are manually paired to selected principles. At the end of this step in the process the user has principles that are paired to specific images that represent those principles.

The selected images that represent those key principles are then use to populate a crest. This crest can represent a family or individual. The imagery in this crest represents those specific and meaningful custom and unique principles chosen by the user. This process results in a family crest that has images symbolic of those underlying principles that are important to the individual or family. This crest can serve as a visual reminder of the family identity and values.

So that the creator of the crest can have a lasting reminder of the imagery on the crest, a set of cards are included for reference. This is critically important because it provides the user with a means of clearly reminding and explaining the symbolism of the images in the crest, and the specific custom quote/verse/attribute associated with that image. This serves as a reminder of the symbolism of the crest in a manner that is easily understood by the individual or family and is unique to this custom crest creation process.

### REFERENCES (INCORPORATED HEREIN BY REFERENCE)

The process can be seen in a computer/internet based presentation at

1. A method, comprising of these steps in any order: identification of key principles represented by quotes, verses and other custom text by an individual or family;
selection of imagery to represent those key principles; pairing the principles and representative images; using those images to populate a crest to reflect those key principles; and creating ‘key cards’ that accompany the crest and associate a specific image with a specific principle/attribute.

2. The method of claim 1 conducted via a computer and internet based interface to conduct this process

3. The creation of cards (‘key cards’) that show the key principles and imagery chosen by the individual to be reflected in the modern family crest. Each card has the representative image and the quote or verse that is reflected by that image.
